(19) United States
(12) Patent Application Publication
(10) Pub. No.: US 2025/0184220 A1
(43) Pub. Date: Jun. 5, 2025

(54) INTENT-BASED SERVICE MANAGEMENT

(71) Applicant: Telefonaktiebolaget LM Ericsson (publ), Stockholm (SE)

(72) Inventors: Malgorzata SVENSSON, Nättraby (SE); Jörg NIEMÖLLER, Sollentuna (SE); Kian JENNINGS, Athlone (IE); Robin KISS, Budapest (HU); Larry O'NEILL, Athlone (IE)

(21) Appl. No.: 18/843,211

(22) PCT Filed: Mar. 15, 2022
(86) PCT No.: PCT/EP2022/056655

§ 371 Date: Aug. 30, 2024

(51) Int. Cl. H04L 41/0816; H04L 41/0869; H04L 41/5054

(52) U.S. Cl. CPC H04L 41/0816; H04L 41/0869; H04L 41/5054

(57) ABSTRACT

A method for configuring a system having a current specification is provided. The method includes receiving specification information identifying a first desired specification of a first requested service for the system and determining whether the system satisfies the first desired specification. Determining whether the system satisfies the first desired specification includes determining whether there are any discrepancies between the first desired specification and the current specification of the system. The method further includes after determining that there is a discrepancy between the first desired specification and the current specification of the system, identifying a first group of one or more configuration changes for the system for fixing said discrepancy and implementing in the system one or more configuration changes included in the first group.

### TECHNICAL FIELD

Disclosed are embodiments related to methods and systems for providing intent-based service management.

### BACKGROUND

Radio Access Network (RAN) virtualization entails migration from custom-built hardware to network functions implemented in software running on generic hardware. By separating network functions from custom-built hardware, RAN network functions from multiple vendors can be run on the same generic hardware, thereby increasing flexibility for service providers.

One of the consequences of RAN virtualization is the need to life-cycle manage a RAN service in the domain defined by the Open-RAN (O-RAN) standardization, which defines the Service Exposure function and sets of Application Programming Interfaces (APIs) referenced as R1. Here, a RAN service is defined as a composition of logical and physical RAN network functions and equipments. An example of a RAN service is a sector carrier service, where a sector carrier equipment and the resources of each transmission point included in a cell are logically connected with a virtualized/physical RAN network functions based on service requirements.

### SUMMARY

However, the current APIs refereed as R1 do not support life-cycle management of RAN services adequately due to their lack of interoperability and integration capabilities with any externals to the O-RAN defined systems. Also, there is no means to support the life-cycle management of RAN services within O-RAN alliance defined standardizations. Thus, there is a need to provide methods and systems for providing a life-cycle management of RAN service(s).

Accordingly, in one aspect of some embodiments of this disclosure, there is provided a method for configuring a system having current specification. The method comprise receiving specification information identifying a first desired specification of a first requested service for the system. The method further comprises determining whether the system satisfies the first desired specification, wherein determining whether the system satisfies the first desired specification comprises determining whether there are any discrepancies between the first desired specification and the current specification of the system. The method further comprises after determining that there is a discrepancy between the first desired specification and the current specification of the system, identifying a first group of one or more configuration changes for the system for fixing said discrepancy. The method further comprises implementing in the system one or more configuration changes included in the first group.

In another aspect, there is provided a method for configuring a system. The method comprises receiving one or more signals identifying an information element comprising (i) a desired service identifier identifying a desired service and (ii) one or more values of one or more operational requirements related to providing the desired service. The method further comprises retrieving from a storage medium one or more current service identifiers identifying one or more current services provided by the system and one or more values of one or more operational states related to providing said one or more current services. The method further comprises identifying a group of one or more configuration changes to be implemented to deliver the desired service based on (i) the desired service identifier and at least one of said one or more current service identifiers and/or (ii) said one or more values of said one or more operational requirements and said one or more values of said one or more operational states. The method further comprises transmitting one or more signals triggering implementation of the group of one or more configuration changes in the system.

In another aspect, there is provided a computer program comprising instructions which when executed by processing circuitry cause the processing circuitry to perform the method of any of the embodiments described above.

In another aspect, there is provided a carrier containing the computer program described above, wherein the carrier is one of an electronic signal, an optical signal, a radio signal, and a computer readable storage medium.

In another aspect, there is provided an apparatus for configuring a system having current specification. The apparatus is configured to receive specification information identifying a first desired specification of a first requested service for the system. The apparatus is further configured to determine whether the system satisfies the first desired specification, wherein determining whether the system satisfies the first desired specification comprises determining whether there are any discrepancies between the first desired specification and the current specification of the system. The apparatus is further configured to, after determining that there is a discrepancy between the first desired specification and the current specification of the system, identify a first group of one or more configuration changes for the system for fixing said discrepancy. The apparatus is further configured to implement in the system one or more configuration changes included in the first group.

In another aspect, there is provided an apparatus for configuring a system. The apparatus is configured to receive one or more signals identifying an information element comprising (i) a desired service identifier identifying a desired service and (ii) one or more values of one or more operational requirements related to providing the desired service. The apparatus is further configured to retrieve from a storage medium and/or from an external module, one or more current service identifiers identifying one or more current services provided by the system and one or more values of one or more operational states related to providing said one or more current services. The apparatus is further configured to identify a group of one or more configuration changes to be implemented to deliver the desired service based on (i) the desired service identifier and at least one of said one or more current service identifiers and/or (ii) said one or more values of said one or more operational requirements and said one or more values of said one or more operational states. The apparatus is further configured to transmit one or more signals triggering implementation of the group of one or more configuration changes in the system.

In another aspect, there is provided an apparatus. The apparatus comprises a processing circuitry and a memory. The memory contains instructions executable by said processing circuitry, whereby the apparatus is operative to perform the method of any one of the methods described above.

Embodiments of this disclosure allow handling life-cycle management of RAN services in a standardized way by applying intent APIs to RAN Service Intent Management Domain architecture which follows the paradigm of a clear separation between platform and applications. In this architecture, applications encompass business logic that that is defined in intent request.

The application of the intent APIs to a RAN service makes the interactions and integrations between the O-RAN defined domain and external domains (e.g., the 3rd Generation Partnership Project (3GPP) domains or TeleManagement Forum (TMF) domains) possible and attractive. It also enables e2e service related use cases as network slicing orchestration and assurance.

The accompanying drawings, which are incorporated herein and form part of the specification, illustrate various embodiments.

### BRIEF DESCRIPTION OF THE DRAWINGS

FIG. 1A shows a system according to some embodiments.

FIG. 1B shows an example of a service providing system according to some embodiments.

FIG. 2 shows a process according to some embodiments.

FIG. 3 shows a message flow diagram according to some embodiments.

FIG. 4 shows a process according to some embodiments.

FIG. 5 shows a process for configuring a system according to some embodiments.

FIG. 6 shows a block diagram of an apparatus according to some embodiments.

### DETAILED DESCRIPTION

Conventionally, in order for a network operator to manage RAN services, the network operator must determine detailed system settings for the RAN services and provide the determined system settings to a system managing the RAN services such that the system is configured according to the given system settings. However, such manual management is generally not efficient and can be problematic as the number of RAN services to manage increases.

To manage RAN services efficiently, an automation of RAN service management is desirable. The automation of the RAN service management enables improving service quality while reducing the management costs. In order to achieve such automation, according to some embodiments of this disclosure, intent-based service management is provided.

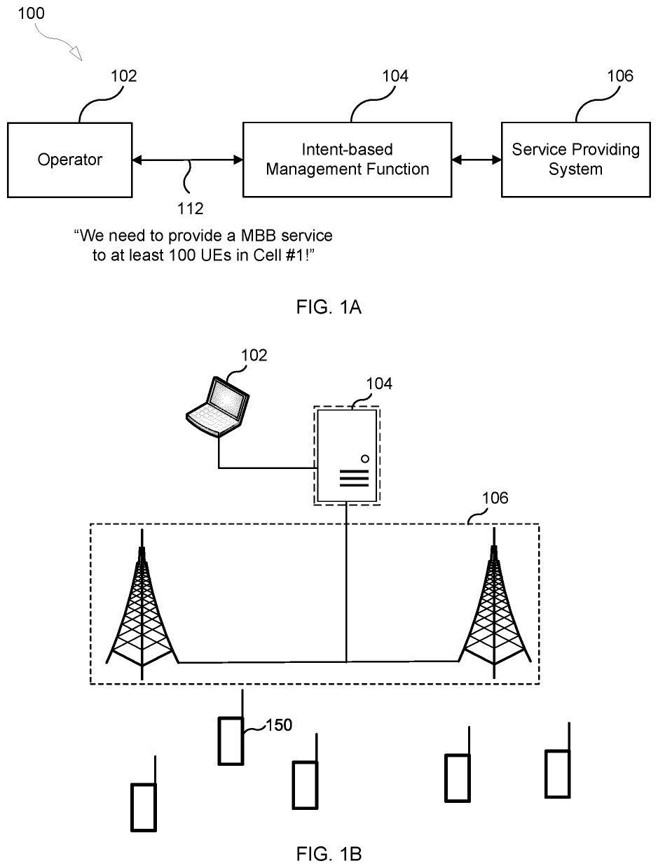

In the intent-based service management, instead of an operator providing detailed system settings to a system, the operator provides intent to an intent management function and the intent management function automatically changes configuration(s) of the system to achieve the intent. FIG. 1A shows a system 100 for providing intent-based service management according to some embodiments.

In FIG. 1A, an operator 102 provides intent 112 to an intent management function (IMF) 104. The operator 102 may be a human, any computing device, or a software module. Intent 112 is not a group of detailed system settings. Rather, it specifies broad expectation(s) given to a service providing system 106. In other words, intent 112 specifies what operator 102 wants from service providing system 106. In the example shown in FIG. 1A, operator 102 wants system 106 to be able to provide mobile broad band (MBB) services to at least one hundred user equipments (UEs) used for emergency services in a particular cell. Intent 112 contains data corresponding to operator 102's such needs.

FIG. 1B shows an example of service providing system 106. As shown in FIG. 1B, one example of service providing system 106 is a system for providing a cellular network (e.g., 5G network) to a plurality of user equipments (UEs). For simplicity, not all entities included in the system is shown in FIG. 1B.

Referring back to FIG. 1A, in this disclosure, “intent” is defined as an information object that defines specification of expectations (including requirements, goals, and constraints) given to a system (e.g. “We need to provide a MBB service to at least 100 UEs in Cell #1!”). Table 1 provided below shows a simplified example of information included in intent 112.

TABLE 1
OBJECT: INTENT

| | |
|---|---|
| Service | Mobile broadband |
| Type | |
| Service | User equipments (UEs) used |
| Target Type | for emergency service |
| Service | one hundred UEs |
| Target Amount | |
| Service | Cell ID |
| Location | |

As shown in Table 1 above, the information included in intent 112 may include a desired service type, a desired service target type, a desired service target amount, and/or a desired service location.

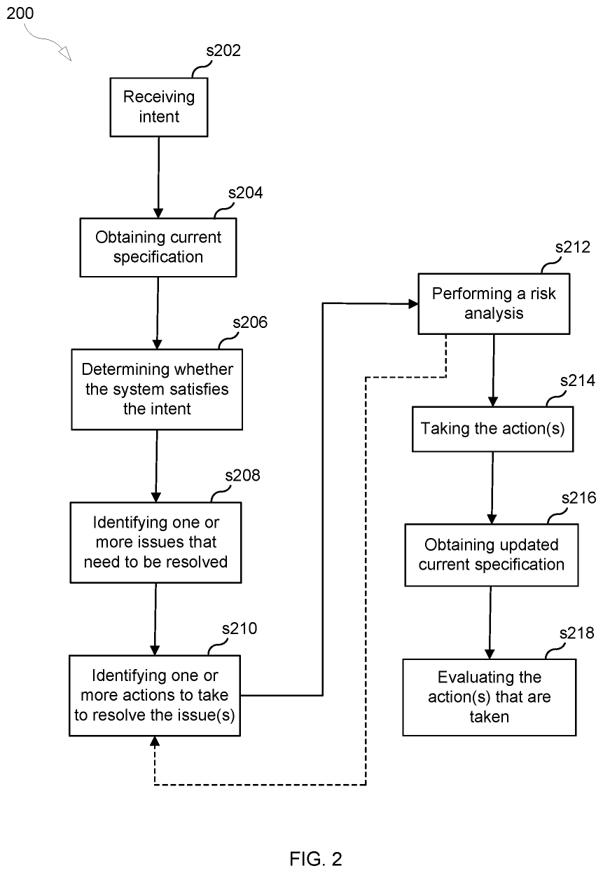

After receiving intent 112, IMF 104 may identify one or more configuration changes and implement the configuration change(s) in system 106. To identify and implement the configuration change(s) in accordance with intent 112, IMF 104 performs various knowledge-centric operations. FIG. 2 shows a simplified process 200 of providing intent-based service management according to some embodiments. Process 200 may be performed by IMF 104.

As shown in FIG. 2, process 200 includes step s202. Step s202 comprises receiving intent 112. As discussed above, “intent” is an information object that defines specification of expectations (including requirements, goals, and constraints) given to a system. In this disclosure, this specification of expectations is also referred as “desired specification.” The desired specification may identify a requested service and one or more operational requirements related to providing the requested service. For example, intent 112 may indicate that a MBB service needs to be available for at least one hundred UE used for emergency services in cell #1. Here, the MBB service corresponds to the requested service and serving at least one hundred UEs used for emergency services in cell #1 corresponds to the operational requirements.

As shown in FIG. 2, after receiving intent 112, IMF 104 performs step s204. Step s204 comprises obtaining current specification of system 106. The current specification of system 106 may identify a list of services that are currently provided by system 106 and include current state data indicating one or more current operational states of system 106. Even though FIG. 2 shows that the step of obtaining the current specification of system 106 is performed after IMF 104 receives intent 112, in some embodiments, the obtaining step may be performed before IMF 104 receives intent 112. The current specification of system 106 may be obtained from a storage medium. The storage medium may be included in IMF 104 or may be included in an external module. Alternatively, some part(s) of the current specification may be obtained from a storage medium included in IMF 104 and other part(s) of the current specification may be obtained from a storage medium included in an external module. The storage medium may be a single integrated entity or a group of distributed entities.

After receiving the desired specification and obtaining the current specification of system 106, in step s206, IMF 104 may determine whether system 106 satisfies the desired specification. More specifically, IMF 104 may determine whether there are any discrepancies (a.k.a., “deviation”) between the desired specification and the current specification of system 106.

In case IMF 104 determines that there is no discrepancy between the desired specification and the current specification of system 106, IMF 104 may wait before it performs a redetermination of whether system 106 satisfies the desired specification. In some embodiments, IMF 104 may wait until a triggering event occurs. Examples of the triggering event are an elapse of a predetermined amount of time interval and an occurrence of one or more configuration changes.

However, there may be a scenario where there is a discrepancy between the desired specification and the current specification of system 106. For example, the current specification of system 106 may indicate that a MBB service is currently available for UEs used for emergency services (a.k.a., “emergency-service UEs”) in cell #1 but only fifty emergency-service UEs can be served. In another example, the current specification of system 106 may indicate that no MBB service is currently available for emergency-service UEs in cell #1. In both examples, IMF 104 may determine that system 106 currently does not satisfy the desired specification.

In case IMF 104 determines that system 106 currently does not satisfy the desired specification, as shown in FIG. 2, process 200 may proceed to step s208 in which IMF 104 identifies one or more issues that need to be solved in order for system 106 to satisfy the desired specification. For example, in the first example discussed above, system 106 does not satisfy the desired specification because only fifty emergency-service UEs can be served in cell #1. In this example, in step s208, IMF 104 may identify one or more issues that need to be solved in order to configure system 106 to be able to service at least fifty more emergency-service UEs. Here, one example of the issues is that not enough bandwidth is available to serve more than fifty emergency-service UEs in cell #1.

After identifying the issue(s), in step s210, IMF 104 may identify one or more actions to take to resolve the issue(s). One or more of the action(s) identified in step s210 may be taken in step s214. The action(s) identified in this step may be added to a knowledge base. The knowledge base may also indicate association(s) between the identified action(s) and the issue(s). Here, taking an action means implementing one or more configuration changes. For example, in the example discussed above, the action(s) to take may include limiting the quality of a video streaming to 480p in cell #1. By limiting the quality of a video streaming, the issue(s) of not having enough bandwidth to serve more than fifty emergency-service UEs may be resolved.

After identifying the action(s) to take, in step s212, IMF 104 may perform a risk analysis. The risk analysis involves identifying a potential risk resulting from implementing the one or more configuration changes. In some embodiments, the potential risk may be related to a violation of another intent that system 100 is configured to achieve. For example, there may be a scenario where system 100 previously received intent information identifying previous intent and the previous intent specifies that system 100 needs to stream 1080p quality videos to UEs subscribed to a particular service. In such scenario, implementing the configuration change of limiting the video streaming quality to 480p would violate the previously implemented intent. Here, such violation of the previous intent constitutes the risk.

If IMF 104 determines that the identified potential risk cannot be taken, process 200 may return to step s210 to identify different action(s). In some embodiments, in step s210, a list of all possible actions may be identified. In such embodiments, after IMF 104 determines that the risk cannot be taken, IMF 104 may choose the second best action to take and reperform the risk analysis.

On the other hand, if IMF 104 determines that the identified potential risk can be taken, process 200 may proceed to step s214. In step s214, IMF 104 may take the action(s) identified in step s210. For example, IMF 104 may implement the configuration change(s) in system 106 such that the quality of a video streaming in cell #1 is limited to 480p.

After performing step s214, IMF 104 may perform step s216. Step s216 comprises obtaining updated current specification of system 106.

After obtaining the updated current specification of system 106, in some embodiments, IMF 104 may proceed to step s218. Step s218 comprises evaluating the action(s) taken in step s214. For example, in step s218, IMF 104 may determine if there are any discrepancies between the updated current specification and the desired specification. In other words, in step s218, IMF 104 may determine whether system 100 satisfies the current intent. However, in other embodiments, instead of or in addition to checking the satisfaction of the current intent, IMF 104 may check whether system 100 satisfies previously received intent.

Step s218 is similar to step s212. This optional step s218 allows system 100 to check the satisfaction of the current intent as well as the previously received intent after the configuration changes are actually implemented (as compared to step 212 in which system 100 predicts whether system 100 would satisfy the current intent and/or the previously received intent if the configuration changes are to be implemented).

In case there is a discrepancy between the updated current specification and the desired specification, process 200 may proceed back to step s208.

On the other hand, in case IMF 104 determines that there is no discrepancy between the desired specification and the updated current specification of system 106, IMF 104 may wait before it performs a redetermination of whether system 106 satisfies the desired specification. In some embodiments, IMF 104 may wait until a triggering event occurs. As discussed above, examples of the triggering event are an elapse of a predetermined amount of time interval and an occurrence of one or more configuration changes.

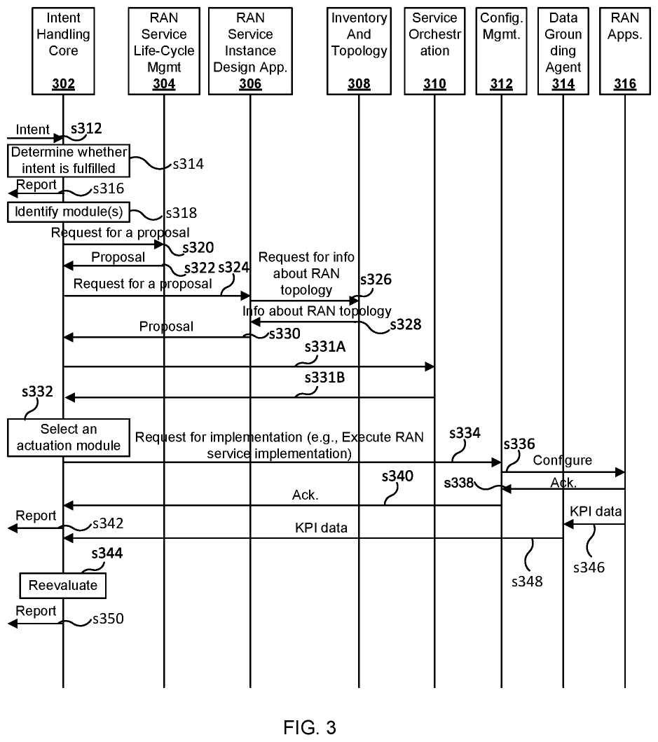

According to some embodiments, IMF 104 may comprise a plurality of modules. Here, a module may be a hardware module and/or a software module. For example, as shown in FIG. 3, IMF 104 may comprise intent handling core 302, RAN service life-cycle management module 304, RAN service instance design application 306, inventory and topology module 308, service orchestration module 310, configuration management module 312, and data grounding agents 314. IMF 104 may be configured to interact with RAN applications 316. In some embodiments, any two or more of the modules included in IMF 104 may be combined into a single entity.

FIG. 3 is a message flow diagram showing interactions between different modules included in IMF 104 and between one or more modules in IMF 104 and an external entity. The interactions may begin with step s312.

Step s312 comprises intent handling core 302 receiving intent 112 (e.g., from operator 102). As discussed above, “intent” is an information object that defines specification of expectations (including requirements, goals, and constraints) given to system 106. As shown in Table 1 provided above, the information included in intent 112 may include a desired service type, a desired service target type, a desired service target amount, and/or a desired service location. In some embodiments, intent handling core 302 may add to a knowledge base the received intent 112.

After receiving intent 112, in step s314, intent handling core 302 may determine whether system 106 satisfies intent 112. Detailed operations involved in determining whether system 106 satisfies intent 112 are already explained with respect to steps s204 and s206 shown in FIG. 2, and thus the explanations are omitted here. After performing step s314, intent handling core 302 may perform step s316. In step s316, intent handling core 302 may transmit to operator 102 a report indicating whether system 106 currently satisfies intent 112 or not.

As discussed with respect to step s204, in determining whether the system 106 satisfies intent 112, intent handling core 302 obtains current specification of system 106. The current specification of system 106 may identify a list of services that are currently provided by system 106 and include current state data indicating one or more current operational states of system 106. In response to intent handling core 302 determining that system 106 currently does not satisfy intent 112, intent handling core 302 may add to the knowledge base the current specification of system 106. For example intent handling core 302 adds to the knowledge base the list of services currently provided by system 106 and/or current state data indicating one or more current operational states of system 106. One example of the current state data is Key Performance Parameters (KPI(s)) of service(s).

After intent handling core 302 determining that system 106 currently does not satisfy intent 112, in step s318, intent handling core 302 may identify one or more modules (a.k.a., “agents”) which may be capable of providing a proposal for configuration change(s) which will likely result in system 106 to satisfy intent 112 when the configuration change(s) is implemented in system 106. In some embodiments, the identified modules may be added to the knowledge base.

In order to identify such module(s), a database may be provided to intent handling core 302. In some embodiments, the database may be stored in intent handling core 302. However, in other embodiments, at least a portion of the database is retrieved from a storage and provided to intent handling core 302.

The database may provide a list of modules and one or more system states each of the modules is associated with. Table 2 provided below shows a simplified example of information included in the database.

TABLE 2

| | System state handled |
|---|---|
| Module Identifier | by each module |
| Module #1 (e.g., RAN service | Not enough bandwidth |
| life-cycle management module) | |
| Module #2 (e.g., RAN service | No service exists |
| instance design application module) | |

Referring back to FIG. 3, in response to intent handling core 302 determining that system 106 currently does not satisfy intent 112, intent handling core 302 may identify one or more system states causing system 106's failure to satisfy intent 112. For example, in the example discussed above, one system state causing the failure may be that not enough bandwidth is available in cell #1. Another system state causing the failure may be that no MBB service is currently available for emergency-service UEs in cell #1. The identified system states may be added to the knowledge base.

If intent handling core 302 identifies that the system state causing the failure is not enough bandwidth is available in cell #1, intent handling core 302 may select RAN service life-cycle management module 304 and, in step s320, transmit to RAN service life-cycle management module 304 a request for a proposal to change/correct the system state causing the failure (e.g., a request to provide possible solution for configuring system 106 to have enough bandwidth in cell #1).

In response to receiving the request, in step s332, RAN service life-cycle management module 304 may identify the issues of the system state causing the failure and determine a proposal to fix the issues. For example, RAN service life-cycle management module 304 may identify that the issue resulting in system 106 not having enough bandwidth is too much bandwidth being used for streaming high quality videos. In such example, the proposal may indicate limiting the quality of a video streaming in cell #1 to 480p. After determining the proposal, RAN service life-cycle management module 304 may transmit to intent handling core 302 the determined proposal.

On the other hand, if intent handling core 302 identifies that the system state causing the failure is that no MBB service is currently available for emergency-service UEs in cell #1, intent handling core 302 may select RAN service instance design application module 306 and transmit, in step s324, to RAN service instance design application module 306 a request for a proposal to change/correct the system state causing the failure (i.e., a request to provide possible solution for configuring system 106 to provide a MBB service for emergency-service UEs in cell #1).

In response to receiving the request, in step s326, RAN service instance design application module 306 may send to inventory and topology module 308 a request for infrastructure/resource information (e.g., information about RAN topology adopted in system 106). In response to receiving the request, in step s328, inventory and topology module 308 may send the requested information to RAN service instance design application module 306.

Based on the infrastructure/resource information, RAN service instance design application module 306 may determine a proposal (i.e., a deployment plan) for system 106 to correct the system state. For example, in the exemplary scenario provided above, the deployment plan may include creating a separate network slice for providing a MBB service for emergency-service UEs. After identifying the action(s), in step s330, RAN service instance design application module 306 may send the proposal to intent handling core 302.

In some embodiments, there may be more than one module configured to handle the same system states, as shown in Table 3.

TABLE

| Module | System state handled by |
|---|---|
| Identifier | each module |
| Module #1 | Not enough bandwidth |
| Module #2 | No service exists |
| Module #2 | Not enough bandwidth |

In such embodiments, intent handling core 302 may receive multiple proposals (i.e., multiple actions to take to make system 106 to satisfy intent 112). In those embodiments, intent handling core 302 may select from the multiple proposals the best proposal. There may be different ways to select the best proposal. In one example, the best proposal may be the one that requires minimum configuration changes. In another example, the best proposal may be the one that affects other services the least. Intent handling core 302 may add the received proposal(s) to the knowledge base.

In step s332, intent handling core 302 may select an actuator module which is capable of implementing the selected proposals (including configuration change(s)). In order to perform such selection, a database may be provided to intent handling core 302. In some embodiments, the database may be stored in intent handling core 302. However, in other embodiments, at least a portion of the database is retrieved from a storage and provided to intent handling core 302.

The database may include a list of actuator modules and the configuration changes the actuator modules can implement. Table 3 below shows a simplified example of such database.

TABLE 3

| Actuation Modules | Configuration Changes |
|---|---|
| Module #1 (e.g., configuration | Restricting the quality |
| management module 312) | of video streaming |
| Module #2 | . . . |

Here, since the suggested configuration change is limiting the quality of video streaming in cell #1 to 480p, in step s332, intent handling core 302 may select configuration management module 312, as mapped in Table 3. Thus, in step s334, intent handling core 302 may transmit to configuration management module 312 a request to implement the suggested configuration change.

In some embodiments, instead of including the configuration changes, each of the multiple proposals intent handling core 302 receives may be in the form of a Topology and Orchestration Specification for Cloud Applications (TOSCA) model describing a proposed system setup. After intent handling core 302 receives the multiple TOSCA models (corresponding to the multiple proposals), intent handling core 302 may select one or more TOSCA models from the received TOSCA models.

In such embodiments, before intent handling core 302 selects an actuator module in step s332, in step s331A, intent handling core 302 may transmit towards service orchestration module 310 a message identifying the selected TOSCA model(s). Upon receiving the message, service orchestration module 310 may interpret the TOSCA model(s) and determine detailed configuration change(s) that need to be made in various resources to implement the selected proposal(s) associated with the selected TOSCA model(s).

In step s331B, service orchestration module 310 may transmit towards intent handling core 302 a message indicating the determined configuration change(s). These embodiments of using TOSCA models and service orchestration module 310 are beneficial because, in these embodiments, the proposals intent handling core 302 receive from RAN service life-cycle management module 304 and RAN service instance design application 306 do not need to include information about detailed configuration change(s). As discussed above, the detailed configuration change(s) are determined by service orchestration module 310.

After receiving the request, in step s336, configuration management module 312 may configure RAN application module(s) 316 to implement the suggested configuration change(s) (e.g., deploying particular RAN application(s)). After implementing the suggested configuration change(s), in step s338, RAN application module(s) 316 may provide to configuration management module 312 an acknowledgement message indicating that the suggested configuration change(s) has been implemented in system 106.

After receiving the acknowledgement message, in step s340, configuration management module 312 may transmit to intent handling core acknowledgement message indicating that the suggested configuration change(s) has been implemented in system 106.

After receiving the acknowledgement message, in step s342, intent handling core 302 may transmit to operator 102 a report indicating whether system 106 currently satisfies intent 112 or not.

In step s344, intent handling core 302 may reevaluate as to whether system 106 satisfies intent 112. Intent handling core 302 may perform the reevaluation right after receiving the acknowledgment message from configuration management module 312 or upon an occurrence of a triggering event. The triggering event may be an elapse of a predefined time period or an occurrence of another configuration change in system 106.

There may be different ways to reevaluate the satisfaction of intent 112. For example, intent handling core may receive current state data indicating the current state of system 106. In one example, the current state data may include Key Performance Indicator(s) (KPIs) indicating the current performance of system 106. In some embodiments, there may be provided data grounding agent(s) 314 configured collect the current state of system 106. For example, in step s346, data grounding agent(s) 314 may receive KPI data from RAN applications 316. After receiving the KPI data, in step s348, data grounding agent(s) 314 may send the KPI data to intent handling core 302.

Upon receiving the current KPI data, during the reevaluation, intent handling core 302 may compare the required KPI stored in the knowledge base with the received current KPI data. In the above provided example, intent 112 specifies that the required latency is 20 ms. Thus, in case the current KPI data indicates that the current latency is greater than 20 ms, intent handling core 302 may determine that system 106 does not currently satisfy intent 112, and the intent-based service management process may go back to step s318.

On the other hand, in case the current KPI data indicates that the current latency is equal to or below 20 ms, intent handling core 302 may determine that system 106 currently satisfy intent 112.

After the reevaluation, in step s350, intent handling core 302 may transmit to operator a report indicating the result of the reevaluation.

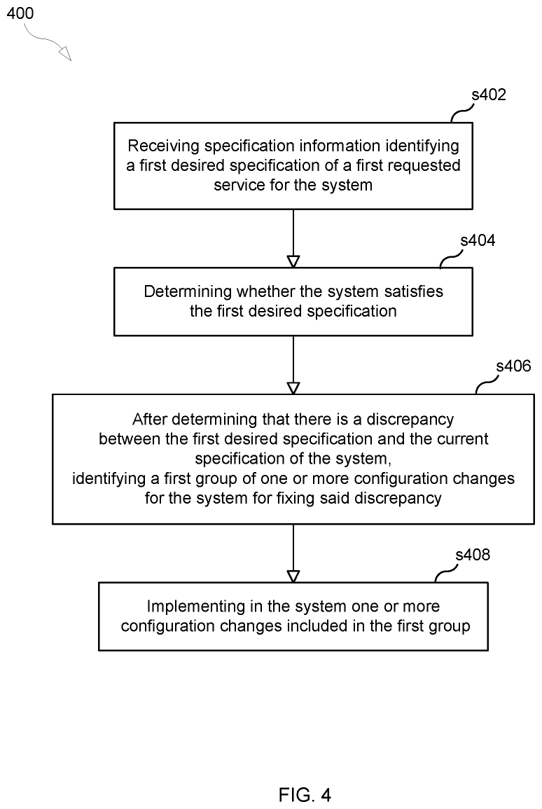

FIG. 4 shows a process 400 for configuring a system having current specification. Process 400 may begin with step s402. Step s402 comprises receiving specification information identifying a first desired specification of a first requested service for the system. Step s404 comprises determining whether the system satisfies the first desired specification, wherein determining whether the system satisfies the first desired specification comprises determining whether there are any discrepancies between the first desired specification and the current specification of the system. Step s406 comprises after determining that there is a discrepancy between the first desired specification and the current specification of the system, identifying a first group of one or more configuration changes for the system for fixing said discrepancy. Step s408 comprises implementing in the system one or more configuration changes included in the first group.

In some embodiments, the method further comprises identifying one or more parameters causing the discrepancy between the first desired specification and the current specification of the system, wherein said one or more configuration changes are for changing said one or more parameters.

In some embodiments, the first desired specification identifies a first requested service and one or more operational requirements related to providing the first requested service.

In some embodiments, determining whether the system satisfies the first desired specification comprises determining whether the system currently provides the first requested service, and/or determining whether said one or more operational requirements of the first requested service are currently satisfied.

In some embodiments, determining whether the system currently provides the first requested service comprises: retrieving inventory information identifying a list of services the system currently provides, and determining whether the first requested service is included in the list of services.

In some embodiments, determining whether said one or more operational requirements of the first requested service are currently satisfied comprises: collecting state data indicating one or more operational states of the system, and using the collected state data, determining whether said one or more operational requirements of the first requested service are currently satisfied.

In some embodiments, determining whether said one or more operational requirements of the first requested service are currently satisfied further comprises comparing the collected state data to said one or more operational requirements of the first requested service, and whether said one or more operational requirements of the first requested service are currently satisfied is determined based on the comparison.

In some embodiments, the method further comprises adding to a first knowledge base any one or more of the followings: (i) information identifying the first requested service; (ii) said one or more operational requirements related to providing the first requested service; (iii) the state data; and (iv) said one or more configuration changes.

In some embodiments, implementing in the system said one or more configuration changes in the first group results in updated current specification, and the method further comprises: receiving second specification information identifying a second desired specification of a second requested service for the system; determining whether the system satisfies the second desired specification, wherein determining whether the system satisfies the second desired specification comprises determining whether there are any discrepancies between the updated current specification and the second desired specification; after determining that there is a discrepancy between the second desired specification and the updated current specification, identifying a second group of one or more configuration changes for the system for fixing the discrepancy between the second desired specification and the updated current specification; and implementing in the system one or more configuration changes included in the second group.

In some embodiments, the method further comprises determining whether the system satisfies the first desired specification, wherein determining whether the system satisfies the first desired specification comprises determining whether there are any discrepancies between the updated current specification and the first desired specification.

In some embodiments, the method further comprises after determining that there is a discrepancy between the first desired specification and the updated current specification, identifying a third group of one or more configuration changes for the system for fixing the discrepancy between the first desired specification and the updated current specification; and implementing in the system one or more configuration changes included in the third group.

In some embodiments, the method further comprises adding to a second knowledge base information identifying the second requested service, wherein the second knowledge base is different from the first knowledge base.

In some embodiments, the method further comprises detecting an occurrence of a triggering event; and as a result of detecting the occurrence of the triggering event, determining whether the system still satisfies the first desired specification.

In some embodiments, the triggering event comprises an elapse of a predefined time period or a configuration change in the system.

In some embodiments, after determining that the system no longer satisfies the first desired specification, identifying another group of one or more configuration changes for the system; and implementing in the system one or more configuration changes included in said another group.

In some embodiments, the method further comprises updating the first knowledge base by adding to the first knowledge base information indicative of said one or more configuration changes included in said another group.

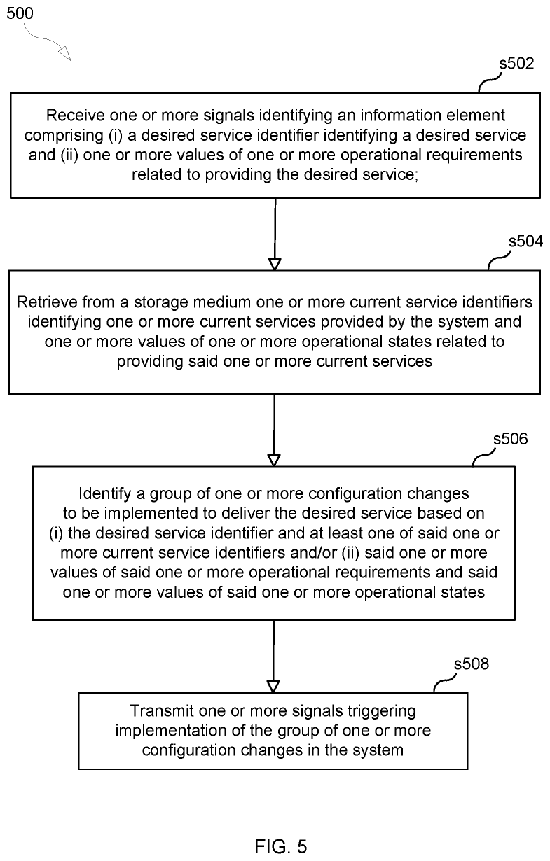

FIG. 5 shows a process 500 for configuring a system. Process 500 may begin with step s502. Step s502 comprises receiving one or more signals identifying an information element comprising (i) a desired service identifier identifying a desired service and (ii) one or more values of one or more operational requirements related to providing the desired service. Step s504 comprises retrieving from a storage medium one or more current service identifiers identifying one or more current services provided by the system and one or more values of one or more operational states related to providing said one or more current services. Step s506 comprises identifying a group of one or more configuration changes to be implemented to deliver the desired service based on (i) the desired service identifier and at least one of said one or more current service identifiers and/or (ii) said one or more values of said one or more operational requirements and said one or more values of said one or more operational states. Step s508 comprises transmitting one or more signals triggering implementation of the group of one or more configuration changes in the system.

In some embodiments, the method further comprises determining whether the desired service identifier is one of said one or more current service identifiers, wherein the group of one or more configuration changes is identified based at least on the determination.

In some embodiments, the method further comprises determining whether said one or more values of said one or more operational states is same as said one or more values of said one or more operational requirements or determining whether said one or more values of said one or more operational states is within a range defined by said one or more values of said one or more operational requirements, wherein the group of one or more configuration changes is identified based at least on the determination.

In some embodiments, the method further comprises adding to a first knowledge base any one or more of the followings: (i) the desired service identifier identifying the desired service; (ii) said one or more values of said one or more operational requirements related to providing the desired service; (iii) said one or more current service identifiers identifying said one or more current services provided by the system; (iv) said one or more values of said one or more operational states related to providing said one or more current services; or (v) the group of one or more configuration changes.

In some embodiments, the method further comprises implementing in the system the group of one or more configuration changes, after implementing the group of one or more configuration changes in the system, retrieving from the storage medium and/or from the external module, one or more updated current service identifiers identifying one or more updated current services provided by the system and one or more values of one or more updated operational states related to providing said one or more updated current services; receiving one or more signals identifying another information element comprising (i) another desired service identifier identifying another desired service and (ii) one or more values of one or more operational requirements related to providing said another desired service; identifying another group of one or more configuration changes to be implemented to deliver said another desired service based on (i) said another desired service identifier and at least one of said one or more updated current service identifiers and/or (ii) said one or more values of said one or more operational requirements related to providing said another desired service and said one or more values of said one or more updated operational states; and transmitting one or more signals triggering implementation of said another group of one or more configuration changes in the system.

In some embodiments, the method further comprises determining whether said another desired service identifier is one of said one or more updated current service identifiers, and/or determining whether said one or more values of said one or more updated operational states is same as said one or more values of said one or more operational requirements related to providing said another desired service or determining whether said one or more values of said one or more updated operational states is within the range defined by said one or more values of said one or more operational requirements related to providing said another desired service.

In some embodiments, the method further comprises determining whether the desired service identifier is one of said one or more updated current service identifiers, and/or determining whether said one or more values of said one or more updated operational states is same as said one or more values of said one or more operational requirements related to providing the desired service or determining whether said one or more values of said one or more updated operational states is within the range defined by said one or more values of said one or more operational requirements related to providing the desired service.

In some embodiments, the method further comprises (i) after determining that said one or more values of said one or more updated operational states is not same as said one or more values of said one or more operational requirements related to providing the desired service or (ii) after determining that said one or more values of said one or more updated operational states is not within the range defined by said one or more values of said one or more operational requirements related to providing the desired service, identifying a different group of one or more configuration changes to be implemented in the system to deliver the desired service while the system satisfying said one or more operational requirements related to providing the desired service.

In some embodiments, the method further comprises adding to a second knowledge base any one or more of the followings: (i) said another desired service identifier identifying said another desired service; (ii) said one or more values of said one or more operational requirements related to providing said another desired service; (iii) said one or more updated current service identifiers identifying said one or more updated current services provided by the system; (iv) said one or more values of said one or more updated operational states related to providing said one or more updated current services; or (v) said another group of one or more configuration changes in the system.

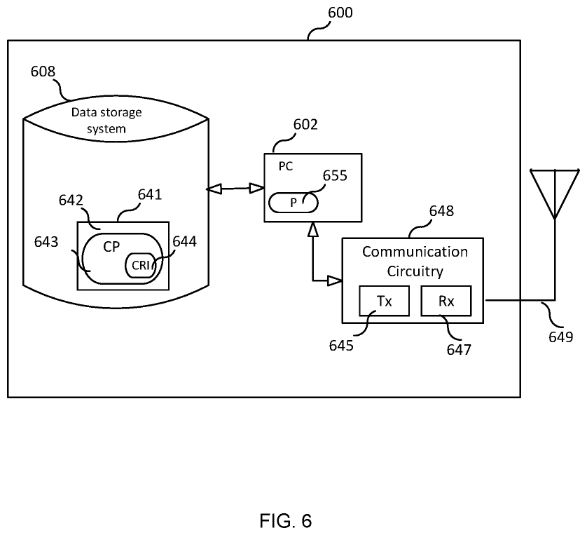

FIG. 6 shows an exemplary structure of each module included in IMF 104 or an exemplary structure of IMF 104 according to some embodiments. As shown in FIG. 6, IMF 104 or a module included in IMF 104 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling IMF 104 or a module included in IMF 104 to transmit data and receive data (e.g., wirelessly transmit/receive data); and a local storage unit (a.k.a., “data storage system”) 608, which may include one or more non-volatile storage devices and/or one or more volatile storage devices. Even though FIG. 6 shows that IMF 104 or a module included in IMF 104 includes communication circuitry 648 which comprises Tx 645 and Rx 647, and antenna arrangement 649, in some embodiments, communication circuitry 648 and antenna arrangement 649 may not be included in IMF 104 or a module included in IMF 104.

In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes IMF 104 or a module included in IMF 104 to perform steps described herein (e.g., steps described herein with reference to the flow charts). In other embodiments, IMF 104 or a module included in IMF 104 may be configured to perform steps described herein without the need for code. That is, for example, PC 602 may consist merely of one or more ASICs. Hence, the features of the embodiments described herein may be implemented in hardware and/or software.

1. A method for configuring a system having current specification, the method comprising:
receiving specification information identifying a first desired specification of a first requested service for the system;
determining whether the system satisfies the first desired specification, wherein determining whether the system satisfies the first desired specification comprises determining whether there are any discrepancies between the first desired specification and the current specification of the system;
after determining that there is a discrepancy between the first desired specification and the current specification of the system, identifying a first group of one or more configuration changes for the system for fixing said discrepancy; and
implementing in the system one or more configuration changes included in the first group.

2. The method of claim 1, further comprising identifying one or more parameters causing the discrepancy between the first desired specification and the current specification of the system, wherein
said one or more configuration changes are for changing said one or more parameters.

3. The method of claim 1, wherein the first desired specification identifies a first requested service and one or more operational requirements related to providing the first requested service.

4. The method of claim 3, wherein determining whether the system satisfies the first desired specification comprises:
determining whether the system currently provides the first requested service, and/or
determining whether the one or more operational requirements of the first requested service are currently satisfied, and
if the system currently provides the first requested service the determining comprises retrieving inventory information identifying a list of services the system currently provides, and
determining whether the first requested service is included in the list of services; and
if the one or more operational requirements of the first requested service are currently satisfied the determining comprises collecting state data indicating one or more operational states of the system, and
using the collected state data, determining whether the one or more operational requirements of the first requested service are currently satisfied, and wherein
determining whether the one or more operational requirements of the first requested service are currently satisfied further comprises comparing the collected state data to the one or more operational requirements of the first requested service, and
whether the one or more operational requirements of the first requested service are currently satisfied is determined based on the comparison.

5.-7. (canceled)

8. The method of claim 4, further comprising adding to a first knowledge base one or more of the following:
(i) information identifying the first requested service;
(ii) said one or more operational requirements related to providing the first requested service;
(iii) the state data; and
(iv) said one or more configuration changes.

9. The method of claim 1, wherein
implementing in the system said one or more configuration changes in the first group results in updated current specification, and
the method further comprises:
receiving second specification information identifying a second desired specification of a second requested service for the system;
determining whether the system satisfies the second desired specification, wherein determining whether the system satisfies the second desired specification comprises determining whether there are any discrepancies between the updated current specification and the second desired specification;
after determining that there is a discrepancy between the second desired specification and the updated current specification, identifying a second group of one or more configuration changes for the system for fixing the discrepancy between the second desired specification and the updated current specification; and
implementing in the system one or more configuration changes included in the second group.

10. The method of claim 9, further comprising determining whether the system satisfies the first desired specification, wherein determining whether the system satisfies the first desired specification comprises determining whether there are any discrepancies between the updated current specification and the first desired specification.

11. The method of claim 10, further comprising:
after determining that there is a discrepancy between the first desired specification and the updated current specification, identifying a third group of one or more configuration changes for the system for fixing the discrepancy between the first desired specification and the updated current specification; and
implementing in the system one or more configuration changes included in the third group.

12. The method of claim 8, further comprising adding to a second knowledge base information identifying the second requested service, wherein
the second knowledge base is different from the first knowledge base.

13. The method of claim 1, further comprising:
detecting an occurrence of a triggering event;
as a result of detecting the occurrence of the triggering event, determining whether the system still satisfies the first desired specification, wherein the triggering event comprises an elapse of a predefined time period or a configuration change in the system;
after determining that the system no longer satisfies the first desired specification, identifying another group of one or more configuration changes for the system;
implementing in the system one or more configuration changes included in said another group; and
updating the first knowledge base by adding to the first knowledge base information indicative of the one or more configuration changes included in said another group.

14.-16. (canceled)

17. A method for configuring a system, the method comprising:
receiving one or more signals identifying an information element comprising a desired service identifier identifying a desired service and one or more values of one or more operational requirements related to providing the desired service;
retrieving from a storage medium one or more current service identifiers identifying one or more current services provided by the system and one or more values of one or more operational states related to providing said one or more current services;
identifying a group of one or more configuration changes to be implemented to deliver the desired service based on the desired service identifier and at least one of said one or more current service identifiers and/or said one or more values of said one or more operational requirements and said one or more values of said one or more operational states; and
transmitting one or more signals triggering implementation of the group of one or more configuration changes in the system.

18. The method of claim 17, further comprising:
determining whether the desired service identifier is one of said one or more current service identifiers, wherein
the group of one or more configuration changes is identified based at least on the determination.

19. The method of claim 17 further comprising:
determining whether said one or more values of said one or more operational states is same as said one or more values of said one or more operational requirements or determining whether said one or more values of said one or more operational states is within a range defined by said one or more values of said one or more operational requirements, wherein
the group of one or more configuration changes is identified based at least on the determination.

20. The method of claim 17, further comprising adding to a first knowledge base any one or more of the following:
(i) the desired service identifier identifying the desired service;
(ii) said one or more values of said one or more operational requirements related to providing the desired service;
(iii) said one or more current service identifiers identifying said one or more current services provided by the system;
(iv) said one or more values of said one or more operational states related to providing said one or more current services; or
(v) the group of one or more configuration changes.

21. The method of claim 17, further comprising:
implementing in the system the group of one or more configuration changes;
after implementing the group of one or more configuration changes in the system, retrieving from the storage medium and/or from the external module, one or more updated current service identifiers identifying one or more updated current services provided by the system and one or more values of one or more updated operational states related to providing said one or more updated current services;
receiving one or more signals identifying another information element comprising (i) another desired service identifier identifying another desired service and (ii) one or more values of one or more operational requirements related to providing said another desired service;
identifying another group of one or more configuration changes to be implemented to deliver said another desired service based on (i) said another desired service identifier and at least one of said one or more updated current service identifiers and/or (ii) said one or more values of said one or more operational requirements related to providing said another desired service and said one or more values of said one or more updated operational states; and
transmitting one or more signals triggering implementation of said another group of one or more configuration changes in the system.

22. The method of claim 21, further comprising:
determining whether said another desired service identifier is one of said one or more updated current service identifiers; and/or
determining whether said one or more values of said one or more updated operational states is same as said one or more values of said one or more operational requirements related to providing said another desired service or determining whether said one or more values of said one or more updated operational states is within the range defined by said one or more values of said one or more operational requirements related to providing said another desired service; and
determining whether the desired service identifier is one of said one or more updated current service identifiers, and/or
determining whether said one or more values of said one or more updated operational states is same as said one or more values of said one or more operational requirements related to providing the desired service or determining whether said one or more values of said one or more updated operational states is within the range defined by said one or more values of said one or more operational requirements related to providing the desired service.

23. (canceled)

24. The method of claim 22, further comprising:
(i) after determining that said one or more values of said one or more updated operational states is not same as said one or more values of said one or more operational requirements related to providing the desired service or (ii) after determining that said one or more values of said one or more updated operational states is not within the range defined by said one or more values of said one or more operational requirements related to providing the desired service, identifying a different group of one or more configuration changes to be implemented in the system to deliver the desired service while the system satisfying said one or more operational requirements related to providing the desired service.

25. The method of claim 21, further comprising adding to a second knowledge base any one or more of the followings-following:
(i) said another desired service identifier identifying said another desired service;
(ii) said one or more values of said one or more operational requirements related to providing said another desired service;
(iii) said one or more updated current service identifiers identifying said one or more updated current services provided by the system;
(iv) said one or more values of said one or more updated operational states related to providing said one or more updated current services; or
(v) said another group of one or more configuration changes in the system.

26.-27. (canceled)

28. An apparatus for configuring a system having current specification, the apparatus comprising:
a processor; and
a memory connected to the processor and storing instructions executable by the processor that is executable by the processor to perform operations comprising:
receive specification information identifying a first desired specification of a first requested service for the system;
determine whether the system satisfies the first desired specification, wherein determining whether the system satisfies the first desired specification comprises determining whether there are any discrepancies between the first desired specification and the current specification of the system;
after determining that there is a discrepancy between the first desired specification and the current specification of the system, identify a first group of one or more configuration changes for the system for fixing said discrepancy; and
implement in the system one or more configuration changes included in the first group.

29. (canceled)

30. An apparatus for configuring a system, the apparatus comprising:
a processor; and
a memory connected to the processor and storing instructions executable by the processor that is executable by the processor to perform operations comprising:
receive one or more signals identifying an information element comprising (i) a desired service identifier identifying a desired service and (ii) one or more values of one or more operational requirements related to providing the desired service;
retrieve from a storage medium and/or from an external module, one or more current service identifiers identifying one or more current services provided by the system and one or more values of one or more operational states related to providing said one or more current services;
identify a group of one or more configuration changes to be implemented to deliver the desired service based on (i) the desired service identifier and at least one of said one or more current service identifiers and/or (ii) said one or more values of said one or more operational requirements and said one or more values of said one or more operational states; and
transmit one or more signals triggering implementation of the group of one or more configuration changes in the system.

31.-32. (canceled)
